(19) United States
(12) Patent Application Publication
(10) Pub. No.: US 2014/0301169 A1
(43) Pub. Date: Oct. 9, 2014

(54) TIMEPIECE CASE WITH INTEGRATED PUSHER AND CROWN

(71) Applicant: Stefan Johansson, Sherman Oaks, CA (US)

(72) Inventor: Stefan Johansson, Sherman Oaks, CA (US)

(73) Assignee: Prophyta Biologischer Pflanzenschutz GmbH, Malchow/Poel (DE)

(21) Appl. No.: 14/342,287

(22) PCT Filed: Sep. 1, 2012
(86) PCT No.: PCT/US12/53565

§ 371 Date: Jun. 23, 2014

Related U.S. Application Data
(60) Provisional application No. 61/530,350, filed on Sep. 1, 2011.

(51) Int. Cl. G04B 37/10; G04B 37/22; G04C 10/00; G04C 1/00; G04B 19/24; G04B 23/02

(52) U.S. Cl. CPC G04B 37/106; G04B 19/24; G04B 23/021; G04C 10/00; G04C 1/00; G04B 37/22
USPC 368/36; 368/308

(57) ABSTRACT

In an exemplary embodiment of a timepiece of the present disclosure, the timepiece comprises a case, a crown extending from the case, a first pusher extending from the case and positioned relative to the crown, a first crown tab positioned between the crown and the first pusher, the first crown tab configured to at least partially surround the crown, a first pusher element extending from the case, the first pusher element configured to at least partially house a first end of the first pusher, a second pusher extending from the case and positioned relative to the crown, a second crown tab positioned between the crown and the second pusher, the second crown tab configured to at least partially surround the crown, and a second pusher element extending from the case, the second pusher element configured to at least partially house a first end of the second pusher.

### PRIORITY

The present International Patent Application is related to, and claims the priority benefit of, U.S. Provisional Patent Application Ser. No. 61/530,350, filed on Sep. 1, 2011, the contents of which are hereby incorporated into the present disclosure in their entirety.

### BACKGROUND

Typical timepieces, such as wristwatches and stopwatches, typically have various elements extending therefrom to set the time and/or date and to control a timer function. However, such timepieces may not only be aesthetically unpleasing due to various knobs, etc., extending therefrom, but they are also subject to damage if they are impacted by a person or another object. For example, dropping a stopwatch could result in one of the buttons extending therefrom from being damaged or broken altogether.

Accordingly, a timepiece configured to protect various elements extending therefrom, and also having an aesthetically-pleasing design, would be well-received in the marketplace.

### BRIEF SUMMARY

In an exemplary embodiment of a timepiece of the present disclosure, the timepiece comprises a case, a crown extending from the case, a first pusher extending from the case and positioned relative to the crown, a first crown tab positioned between the crown and the first pusher, the first crown tab configured to at least partially surround the crown, and a first pusher element extending from the case, the first pusher element configured to at least partially house a first end of the first pusher. In another embodiment, the timepiece further comprises a second pusher extending from the case and positioned relative to the crown. In yet another embodiment, the timepiece further comprises a second crown tab positioned between the crown and the second pusher, the second crown tab configured to at least partially surround the crown. In an additional embodiment, the timepiece further comprises a second pusher element extending from the case, the second pusher element configured to at least partially house a first end of the second pusher.

In an exemplary embodiment of a timepiece of the present disclosure, the crown is configured to adjust one or more watch hands appearing upon a face of the timepiece. In an additional embodiment, the crown is configured to adjust one or more of a month, a date, and a year appearing upon a face of the timepiece. In yet an additional embodiment, the first pusher is configured to start and/or stop a watch timer appearing upon a face of the timepiece. In another embodiment, the second pusher is configured to start and/or stop a watch timer appearing upon a face of the timepiece.

In an exemplary embodiment of a timepiece of the present disclosure, the first pusher element, the first pusher, and the first crown tab define a first outer contour. In another embodiment, the second pusher element, the second pusher, and the second crown tab define a second outer contour. In yet another embodiment, the crown comprises a grip portion. In an additional embodiment, the crown comprises indicia thereon. In an exemplary embodiment of a timepiece of the present disclosure, the first pusher comprises a first pusher hinge configured to allow movement of the first pusher relative to the case. In an additional embodiment, the second pusher comprises a second pusher hinge configured to allow movement of the second pusher relative to the case.

In an exemplary embodiment of a timepiece of the present disclosure, the timepiece comprises a case, a crown extending from the case, a first pusher extending from the case and positioned relative to the crown, a first crown tab positioned between the crown and the first pusher, the first crown tab configured to at least partially surround the crown, a first pusher element extending from the case, the first pusher element configured to at least partially house a first end of the first pusher, a second pusher extending from the case and positioned relative to the crown, a second crown tab positioned between the crown and the second pusher, the second crown tab configured to at least partially surround the crown, and a second pusher element extending from the case, the second pusher element configured to at least partially house a first end of the second pusher. In another embodiment, the timepiece is further operable to display a day. In yet another embodiment, the timepiece is further operable to display a month. In an additional embodiment, the timepiece is further operable to display a year.

In an exemplary embodiment of a timepiece of the present disclosure, the timepiece further operable to set and operate an alarm. In an additional embodiment, the timepiece is operable using a battery. In yet an additional embodiment, the timepiece is operable by way of manual or self-winding. In another embodiment, the timepiece comprises one or more materials selected from the group consisting of metal, wood, plastic, rubber, glass, and plastic. In yet another embodiment, the first pusher, the second pusher, and/or one or more crown tabs has indicia printed thereon, embedded therein, and/or protruding therefrom.

### BRIEF DESCRIPTION OF THE DRAWINGS

The above mentioned embodiments and other features, advantages and disclosures contained herein, and the manner of attaining them, will become apparent and the present disclosure will be better understood by reference to the following description of various exemplary embodiments of the present disclosure taken in conjunction with the accompanying drawings, wherein:

FIGS. 1-15 show various views of timepieces according to various embodiments of the present disclosure.

Like reference numerals indicate the same or similar parts throughout the several figures.

An overview of the features, functions and/or configuration of the components depicted in the various figures will now be presented. It should be appreciated that not all of the features of the components of the figures are necessarily described. Some of these non-discussed features, such as various couplers, etc., as well as discussed features are inherent from the figures. Other non-discussed features may be inherent in component geometry and/or configuration.

### DETAILED DESCRIPTION

For the purposes of promoting an understanding of the principles of the present disclosure, reference will now be made to the embodiments illustrated in the drawings, and specific language will be used to describe the same. It will nevertheless be understood that no limitation of the scope of this disclosure is thereby intended.

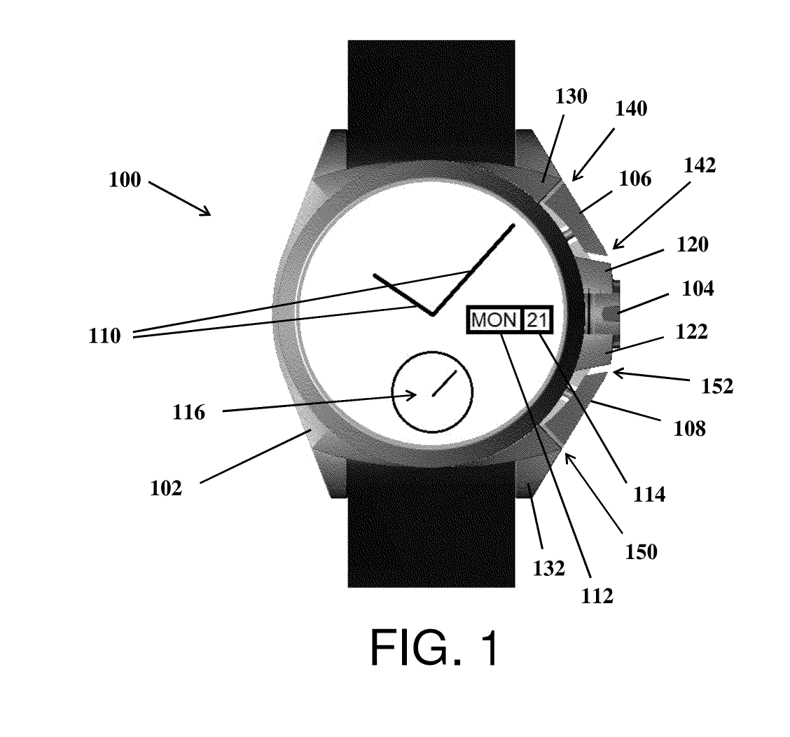

A front view of an exemplary embodiment of a timepiece of the present disclosure is shown in FIG. 1. As shown in FIG. 1, timepiece 100 comprises a case 102, a crown 104, and at least one pusher. In the embodiment shown in FIG. 1, timepiece comprises a first pusher 106 and a second pusher 108. Crown 104, in at least one embodiment, may be used to adjust one or more watch hands 110, a month 112, a date 114, and/or a year (not shown) displayed on the face of timepiece 100. Various pushers 106, 108 may be used to, for example, start and/or stop a watch timer 116, for example.

As shown in FIG. 1, case 102 is configured to protect crown 104 and to incorporate pushers 106, 108 therein. For example, and as shown in FIG. 1, case 102 comprises one or more crown tabs 120, 122, whereby crown tabs 120 are configured to surround at least part of crown 104 to not only protect crown 104 from potential impact and/or damage, but also to resist unintentional winding of crown 104 in at least one embodiment. Crown tabs 120, as shown in FIG. 1 are part of case 102 and extend from case 102 to at least partially surround crown 104.

Furthermore, and as shown in FIG. 1, case 102 further comprises a first pusher element 130 and a second pusher element 132, whereby first pusher element 130 is configured to protect and at least partially house a first end 140 of first pusher 106, and whereby crown tab 120 is configured to protect and at least partially house a second end 142 of first pusher 106. Similarly, second pusher element 132 is configured to protect and at least partially house a first end 150 of second pusher 108, and whereby crown tab 122 is configured to protect and at least partially house a second end 152 of second pusher 108. As shown in FIG. 1, the combination of first pusher element 130 and crown tab 120 allow first pusher 106 to be positioned therebetween and so that first pusher element 130, crown tab 120, and first pusher 106 share or substantially share the same outer contour. Similarly, the combination of second pusher element 132 and crown tab 122 allow second pusher 108 to be positioned therebetween and so that second pusher element 132, crown tab 122, and second pusher 108 share or substantially share the same outer contour.

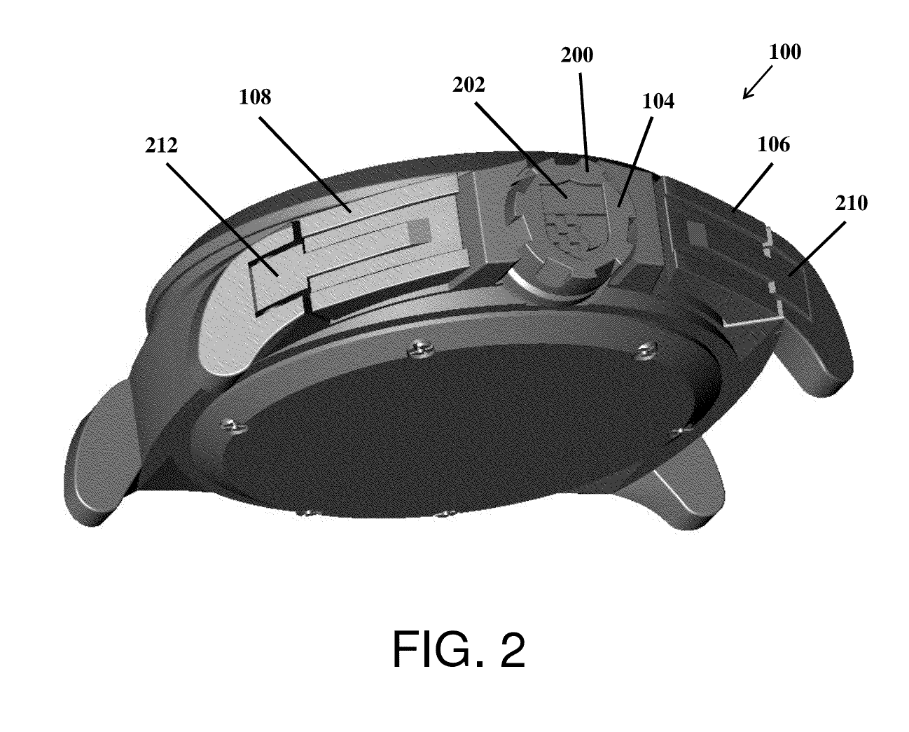

FIG. 2 shows a lower perspective view of at least one embodiment of a timepiece 100 of the present disclosure. As shown in FIG. 2, and in at least one embodiment, crown 104 comprises a grip portion 200 (such as small notches as shown in FIG. 2), as well as indicia 202 printed upon and/or embedded within at least part of crown 104. Grip portion 200 would facilitate turning of crown 104 by a user.

In addition, and as shown in FIG. 2, first pusher 106 may comprise a first pusher hinge 210, and second pusher 108 may comprise a second pusher hinge 212. First pusher hinge 210 and second pusher hinge 212, in at least one embodiment, allow for first pusher 106 and second pusher 108 to be pushed inward and retract back to their original position.

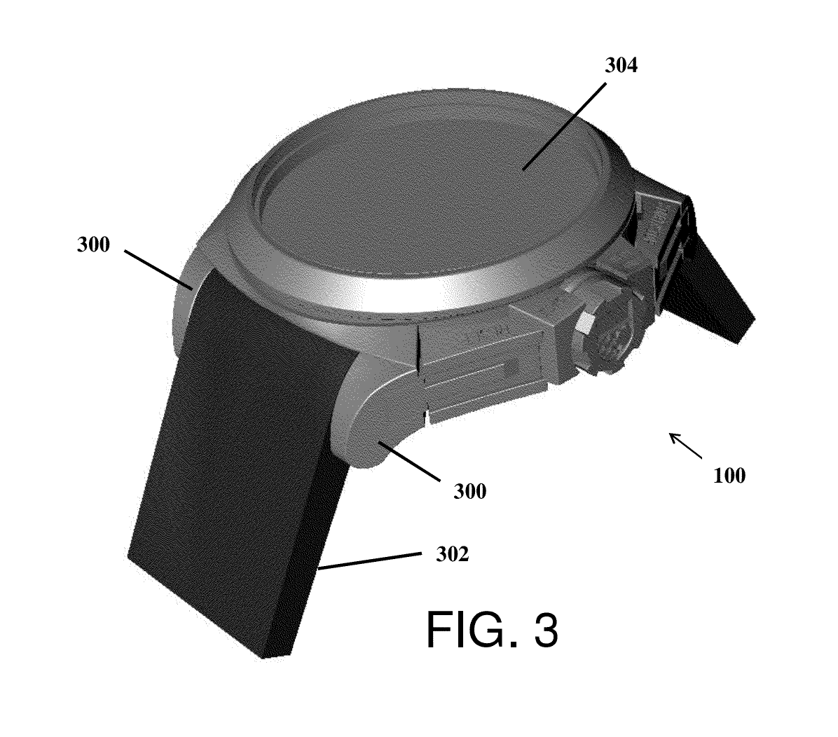

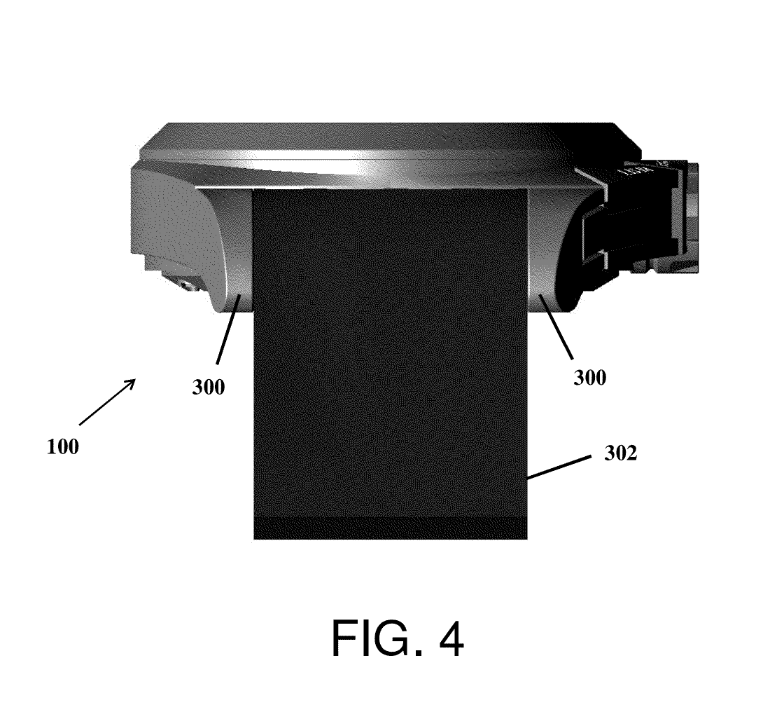

FIG. 3 shows a perspective view, and FIG. 4 shows a bottom side view, of an exemplary timepiece 100 of the present disclosure. As shown therein, and in at least one embodiment, case 102 defines a plurality of band protrusions 300 configured to support a watch band 302. In addition, and as shown in FIG. 3, a face 304 of an exemplary timepiece 100 is shown, whereby any number of watch hands 110, etc., may be positioned thereon.

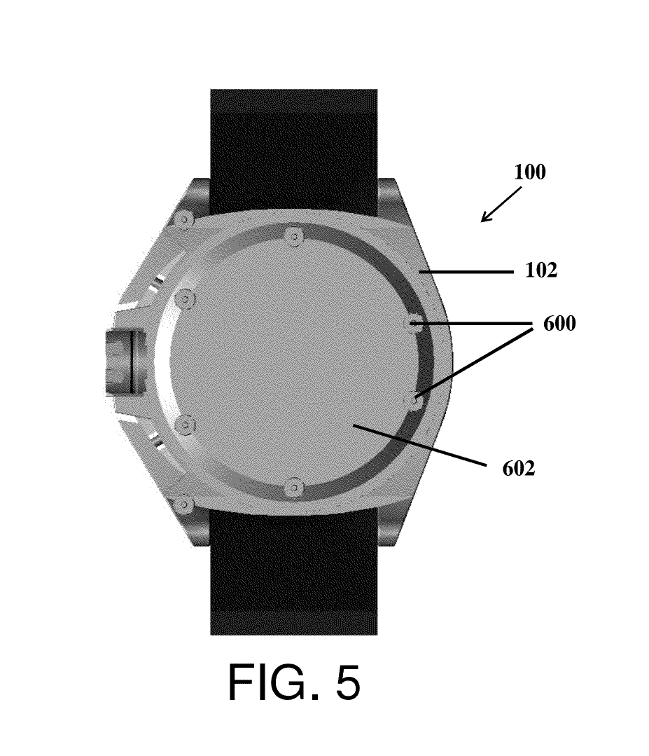

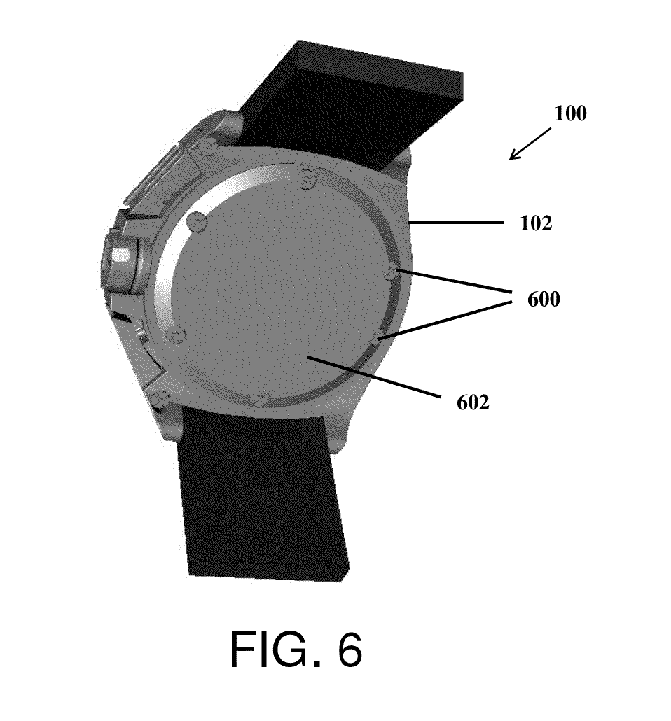

FIG. 5 shows a rear view, and FIG. 6, shows a rear perspective view, of an exemplary timepiece 100 of the present disclosure. As shown therein, and in at least one embodiment, timepiece 100 comprises one or more fasteners 600 (such as screws, for example), useful to attach a watch back plate 602 to case 102.

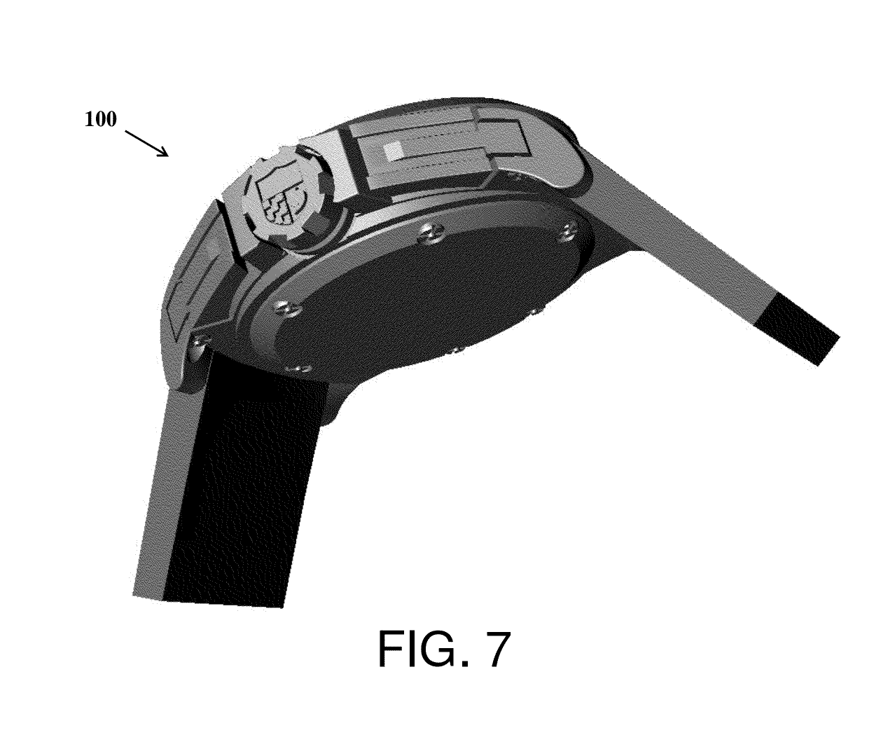

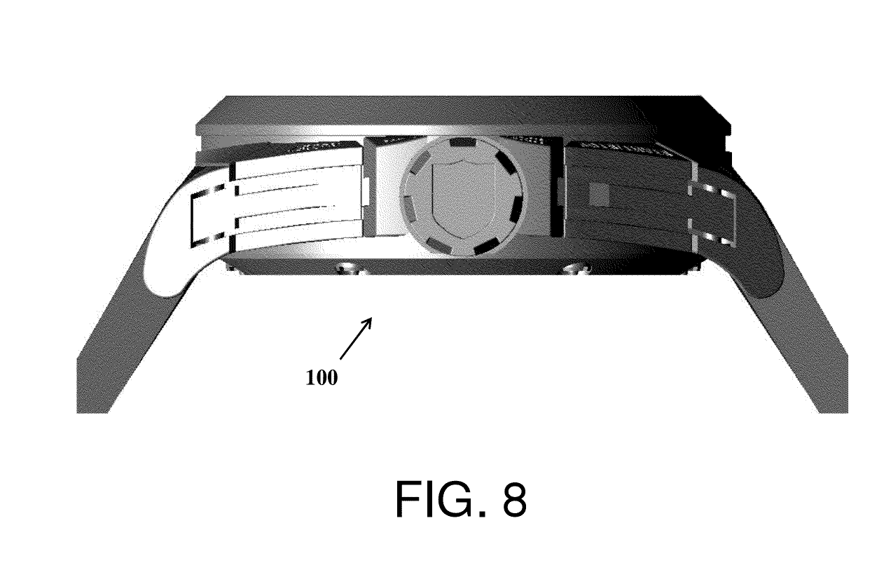

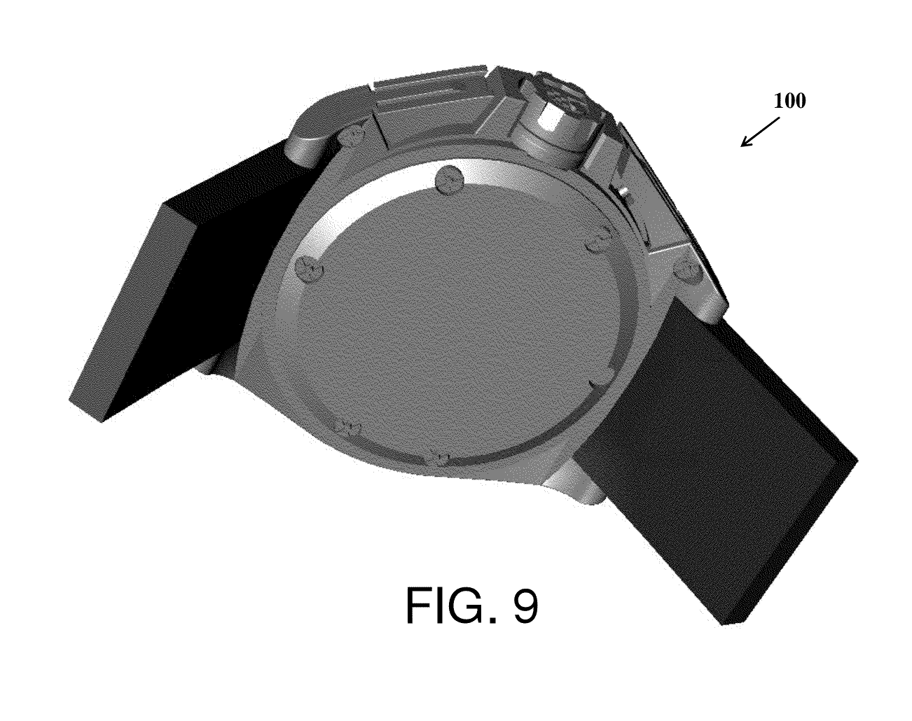

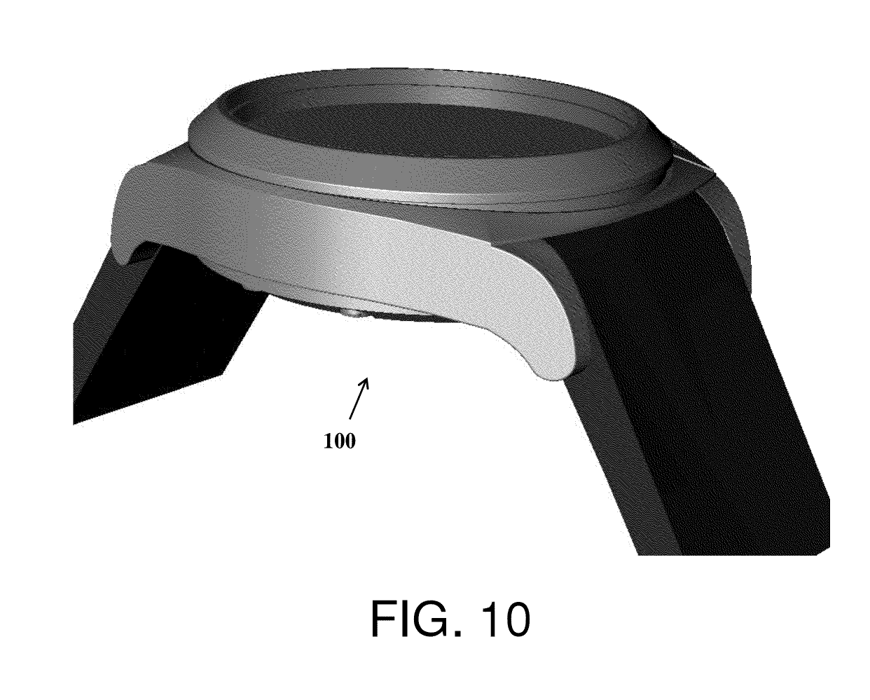

Additional views of exemplary timepieces 100 of the present disclosure are shown in FIGS. 7-10. As shown therein, FIG. 7 shows a lower perspective view, FIG. 8 shows a side view, FIG. 9 shows another lower perspective view, and FIG. 10 shows a side perspective view of various embodiments of timepieces 100 of the present disclosure.

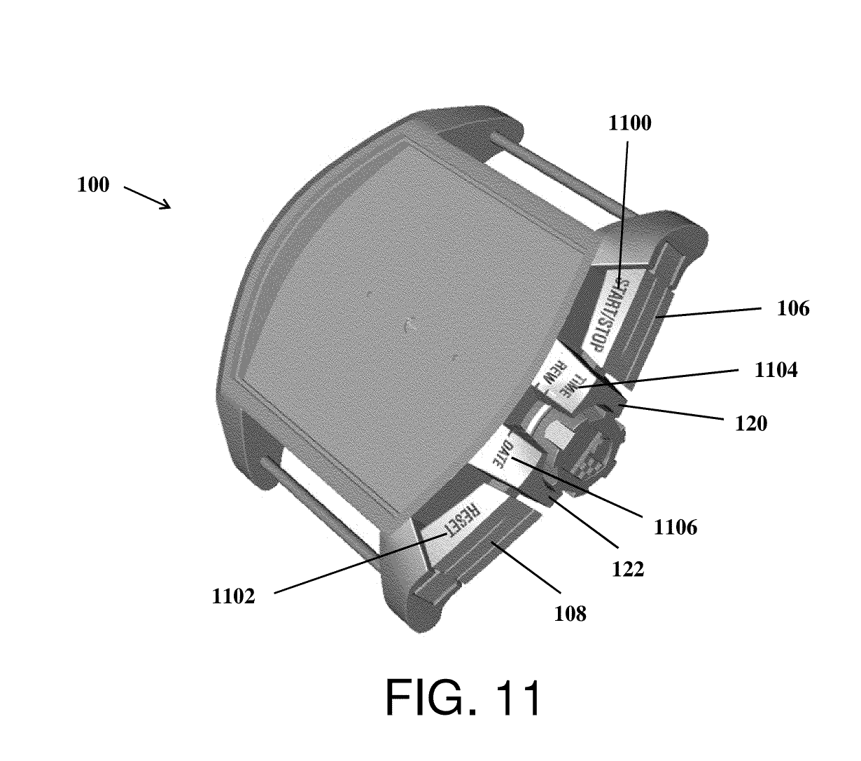

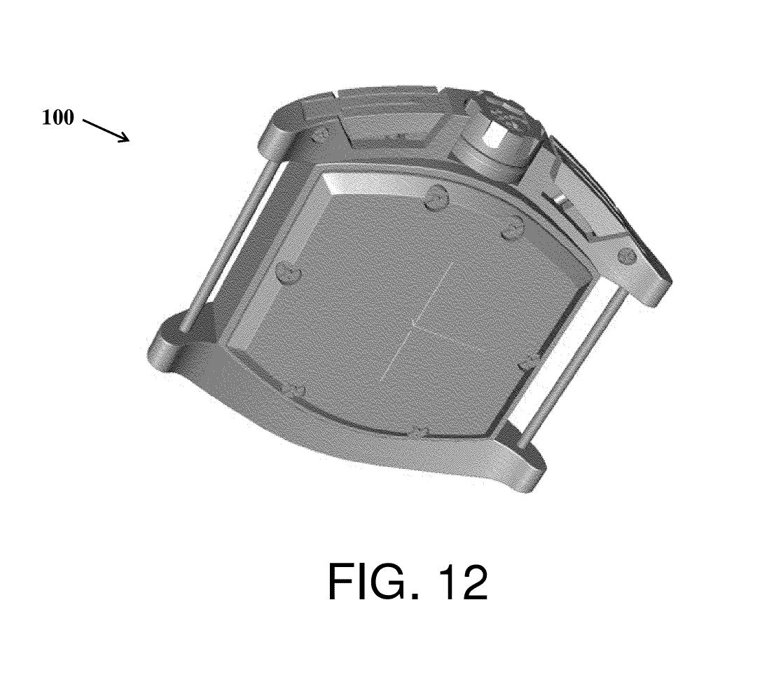

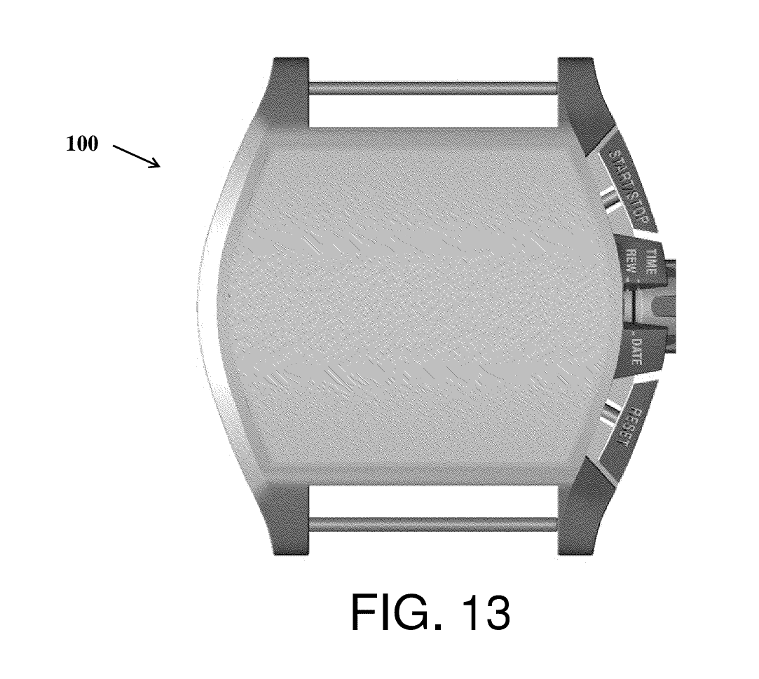

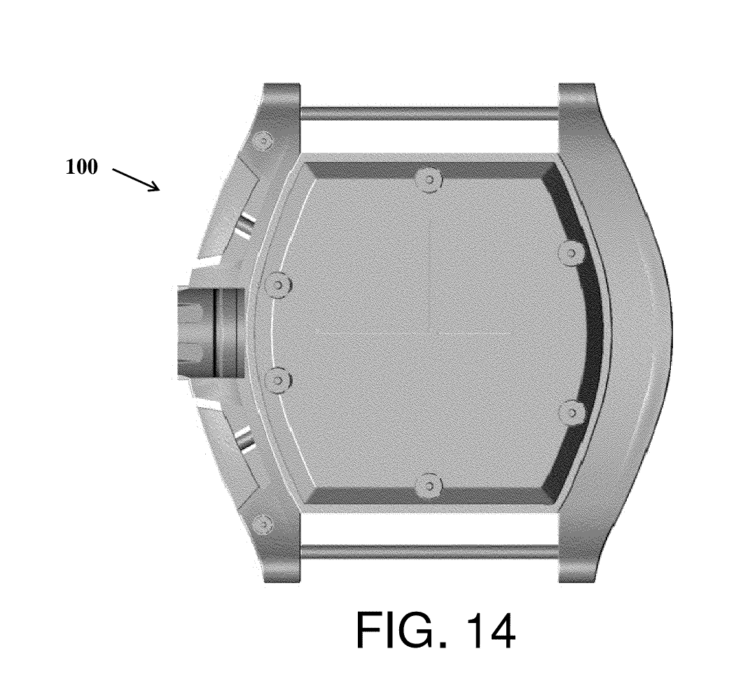

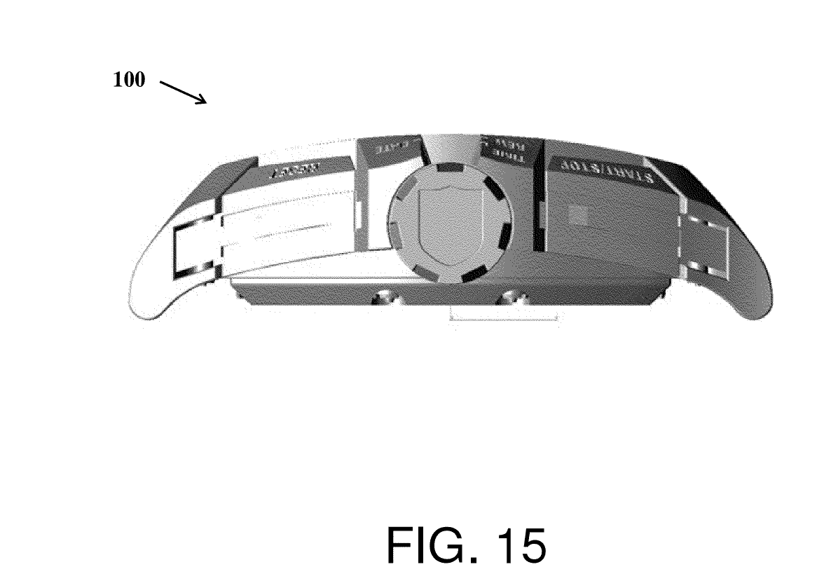

In addition to the relatively round embodiment shown in FIGS. 1-10, various other embodiments are within the scope of the present disclosure, including, but not limited to, those shown in FIGS. 11-15. FIG. 11 shows an upper perspective view of an exemplary timepiece 100 of the present disclosure, and FIG. 12 shows a lower perspective view of the same embodiment. FIGS. 13 and 14 show front and back views, respectively, of exemplary timepieces 100 of the present disclosure, and FIG. 15 shows a side view of an exemplary timepiece 100.

As shown in FIG. 11, for example, various timepieces 100 of the present disclosure may show various indicia printed thereon, embedded therein, and/or protruding therefrom. For example, and as shown in FIG. 11, first pusher 106 may have first pusher indicia 1100, second pusher 108 may have second pusher indicia 1102, and crown tabs 120, 122 may have crown tab indicia 1104, 1106 printed thereon, embedded therein, and/or protruding therefrom.

As referenced above, and in various timepiece 100 embodiments of the present disclosure, the combination of one or more crown tabs 120, 122 can be used to protect crown 104, and the combination of one or more pusher elements 130, 132, in conjunction with crown tabs 120, 122, can be used to protect pushers 106, 108 and create respective contours on either side of crown 104. As referenced herein, the contours are the outer curvatures/portions of timepieces 100 of the present disclosure in connection with the pushers 106, 108 and components positioned adjacent thereto. Said contours also increase the overall aesthetic nature of various timepieces 100 of the present disclosure. In addition, and as generally referenced herein, timepieces 100 may have any number of general shapes, including, but not limited to, those shown in FIGS. 1-10 and 11-15.

Various other components of timepieces known in the art may be used in connection with timepieces 100 of the present disclosure. For example, various other components (such as watch band clasps, batteries, time component mechanisms, etc.), configurations (such as stopwatches), and materials (such as metal, wood, plastic, rubber, glass, plastic, and/or a combination of the same) are considered to be within the scope and spirit of the present disclosure.

While various embodiments of timepieces with integrated pushers and crowns and methods for using the same have been described in considerable detail herein, the embodiments are merely offered by way of non-limiting examples of the disclosure described herein. It will therefore be understood that various changes and modifications may be made, and equivalents may be substituted for elements thereof, without departing from the scope of the disclosure. Indeed, this disclosure is not intended to be exhaustive or to limit the scope of the disclosure.

Further, in describing representative embodiments, the disclosure may have presented a method and/or process as a particular sequence of steps. However, to the extent that the method or process does not rely on the particular order of steps set forth herein, the method or process should not be limited to the particular sequence of steps described. Other sequences of steps may be possible. Therefore, the particular order of the steps disclosed herein should not be construed as limitations of the present disclosure. In addition, disclosure directed to a method and/or process should not be limited to the performance of their steps in the order written. Such sequences may be varied and still remain within the scope of the present disclosure.

1. A timepiece, comprising:
a case;
a crown extending from the case;
a first pusher extending from the case and positioned relative to the crown;
a first crown tab positioned between the crown and the first pusher, the first crown tab configured to at least partially surround the crown; and
a first pusher element extending from the case, the first pusher element configured to at least partially house a first end of the first pusher.

2. The timepiece of claim 1, further comprising:
a second pusher extending from the case and positioned relative to the crown.

3. The timepiece of claim 2, further comprising:
a second crown tab positioned between the crown and the second pusher, the second crown tab configured to at least partially surround the crown.

4. The timepiece of claim 3, further comprising:
a second pusher element extending from the case, the second pusher element configured to at least partially house a first end of the second pusher.

5. The timepiece of claim 1, wherein the crown is configured to adjust one or more watch hands appearing upon a face of the timepiece.

6. The timepiece of claim 1, wherein the crown is configured to adjust one or more of a month, a date, and a year appearing upon a face of the timepiece.

7. The timepiece of claim 1, wherein the first pusher is configured to start and/or stop a watch timer appearing upon a face of the timepiece.

8. The timepiece of claim 2, wherein the second pusher is configured to start and/or stop a watch timer appearing upon a face of the timepiece.

9. The timepiece of claim 1, wherein the first pusher element, the first pusher, and the first crown tab define a first outer contour.

10. The timepiece of claim 4, wherein the second pusher element, the second pusher, and the second crown tab define a second outer contour.

11. The timepiece of claim 1, wherein the crown comprises a grip portion.

12. The timepiece of claim 1, wherein the crown comprises indicia thereon.

13. The timepiece of claim 1, wherein the first pusher comprises a first pusher hinge configured to allow movement of the first pusher relative to the case.

14. The timepiece of claim 2, wherein the second pusher comprises a second pusher hinge configured to allow movement of the second pusher relative to the case.

15. A timepiece, comprising:
a case;
a crown extending from the case;
a first pusher extending from the case and positioned relative to the crown;
a first crown tab positioned between the crown and the first pusher, the first crown tab configured to at least partially surround the crown;
a first pusher element extending from the case, the first pusher element configured to at least partially house a first end of the first pusher;
a second pusher extending from the case and positioned relative to the crown;
a second crown tab positioned between the crown and the second pusher, the second crown tab configured to at least partially surround the crown; and
a second pusher element extending from the case, the second pusher element configured to at least partially house a first end of the second pusher.

16. The timepiece of claim 15, wherein the timepiece is further operable to display a day.

17. The timepiece of claim 16, wherein the timepiece is further operable to display a month.

18. The timepiece of claim 17, wherein the timepiece is further operable to display a year.

19. The timepiece of claim 18, wherein the timepiece further operable to set and operate an alarm.

20. The timepiece of claim 19, wherein the timepiece is operable using a battery.

21. The timepiece of claim 20, wherein the timepiece is operable by way of manual or self-winding.

22. The timepiece of claim 21, wherein the timepiece comprises one or more materials selected from the group consisting of metal, wood, plastic, rubber, glass, and plastic.

23. The timepiece of claim 22, as applicable, wherein the first pusher, the second pusher, and/or one or more crown tabs has indicia printed thereon, embedded therein, and/or protruding therefrom.
